(19) United States
(12) Patent Application Publication
(10) Pub. No.: US 2010/0318900 A1
(43) Pub. Date: Dec. 16, 2010

(54) METHOD AND DEVICE FOR ATTRIBUTING TEXT IN TEXT GRAPHICS

(75) Inventor: Alex Racic, Pullach (DE)

Correspondence Address: SUGHRUE MION, PLLC, 2100 PENNSYLVANIA AVENUE, N.W., SUITE 800, WASHINGTON, DC, 20037, US

(73) Assignee: BOOKRIX GMBH & CO. KG, Munich (DE)

(21) Appl. No.: 12/867,696

(22) PCT Filed: Feb. 9, 2009
(86) PCT No.: PCT/EP2009/001001

§ 371 Date: Aug. 13, 2010

(30) Foreign Application Priority Data
Feb. 13, 2008 (DE) 10 2008 009 442.0

(51) Int. Cl. G06F 17/20

(52) U.S. Cl. 715/243

(57) ABSTRACT

The invention relates to a method for assigning text attributes to a graphical display of text that is contained in a computer graphic, comprising the steps: determination of at least one word position value, which has a co-ordinate tuple related to the fist computer graphic, for a word in the text displayed in the first computer graphic; evaluation of at least one selection position value which has a co-ordinate tuple related to the first computer graphic; check as to whether the word position value for the word is registered by the selection position value by comparing the co-ordinate tuples for the word position value and the selection position value; determination of an attribution area of the first computer graphic on the basis of the word position value registered by the selection position value; and modification of the first computer graphic at least in the attribution area. The invention also relates to a device, an assembly and a computer programme product for said method.

### TECHNICAL FIELD

The invention relates to a method for assigning text attributes to a graphical representation of text which is contained in a computer graphic, and to an apparatus, an arrangement and a computer program product therefor.

### BACKGROUND TO THE INVENTION

In systems for presenting and processing natural-language text, for example in word processing programs or text editors, it is known practice to select text passages in order to assign attributes to them, such as paragraph styles, highlighting, font, font size, font style, color, tracking, etc.

In this case, the text, which is in character-encoded form in systems of this kind, needs to be selected by means of appropriate user interaction by virtue of the user clicking on the start of the text passage to be selected, for example, using a mouse or a touch-sensitive screen and dragging to the end of the passage to be selected. Such selection is described in the system according to the German translation DE 695 19 905 T2 of European patent specification EP 0 698 845 B1. As a result of the text being in character-encoded form, the text is for this purpose easily able to be identified and processed further, depending on the attribute to be assigned or the data processing operation provided for the selected text.

In order to select portions of a computer graphic, it is known practice to define a selection, or capture, rectangle by clicking the rectangle origin and dragging to the rectangle end. This typically involves the graphic elements (pixels in the case of a raster graphic) being marked within the exact dimensions of the capture rectangle.

However, it would also be desirable to be able to assign an attribute to text passages which are not in character-encoded form but rather are presented as a computer graphic, for example a raster graphic, in the text. Such a graphic embodying text is also called text graphic.

Text contained in a text graphic eludes the usual selection and processing methods which are applied for text available in character-encoded form. The computer can only access pixels of the raster graphic forming the text graphic (or vector elements of a vector graphic) and has no directly processable information about the characters and groupings of the text in the text graphic.

The German translation DE 694 34 434 T2 of the European patent specification EP 0 731 948 B1 discloses a system for the user-friendly display and handling of text graphics, wherein the text graphics are from scanned-in pages of printed patent documents, and in which the text presented in the text graphics is also available in a parallel data management system in character-encoded form. In this case, the pagination of scanned-in printed pages of patent specifications is recreated in the character-encoded text form, and a form of presentation is possible in which the text graphic and the character-encoded text are presented in windows situated beside one another. This double approach firstly provides the faithful graphical representation and secondly allows the character-encoded text to be processed further, particularly searching and navigating within a document.

However, this approach requires double data management, which fundamentally increases the need for memory, and in the case of network applications also for communication bandwidth, to a significant degree, since the graphically encoded and character-encoded text needs to be transmitted in each case. In addition, although the text contained in the text graphic is in this case able to be edited using the customary editing methods for graphics, such as enlarging, reducing, rotating, etc., no text-specific attributions are performed.

It is therefore an object of the present invention to specify a method which allows text attributes to be assigned to a graphical representation of text which is contained in a computer graphic, and in so doing avoids the drawbacks of the prior art, and also an apparatus, an arrangement and a computer program product therefor.

### OVERVIEW OF THE INVENTION

The invention achieves said object by means of the respective subject matter of claims 1, 14 and 27 to 29.

The invention according to claim 1 teaches a method for assigning text attributes to a graphical representation of text which is contained in a computer graphic, having the following steps:
a first computer graphic which has a graphical representation of text is selected;
at least one word position value which has a coordinate tuple related to the first computer graphic is determined for a word of the text represented in the first computer graphic;
at least one selection position value which has a coordinate tuple related to the first computer graphic is evaluated;
a check is performed to determine whether the word position value for the word is covered by the selection position value by comparing the coordinate tuples of the word position value and the selection position value;
an attribution region for the first computer graphic is determined on the basis of the word position value covered by the selection position value;
the first computer graphic is modified at least in the attribution region.

As a result of a word position value being determined for a word represented in the text graphic, it becomes possible to address individual words from the text graphic and to use them for the further processing and assignment of attributes. This allows words contained in the text graphic to be processed without carrying a character-encoded text version in parallel. This reduces the need for memory and communication bandwidth. In addition, the character-encoded “source text” of the document presented in the text graphic does not need to be transmitted to the sphere of influence of the user for presentation. As a result of the word position value stipulating a coordinate tuple for the text graphic, for example a book page representation, an identification value which is efficient in terms of data is chosen which simultaneously allows the explicit identification of a word.

The evaluation of the selection position value allows those words of the text graphic which are to be subjected to the assignment of text attributes (attribution) to be selected from the set of all the words in the text graphic. The selection position value, which is therefore a selection feature, may have been determined by interaction of the user or by one or more stored database entries, for example. Thus, the selection position value can determine one or more (selection) points or (selection) regions in the text graphic, for example. The check on whether a word is covered by a selection position value is performed for each word in the text graphic by means of a comparison between the respective word position value of the word and the selection position value. The finding on the basis of a comparison operation allows flexible stipulation of the criteria which need to be applied for a selection.

In contrast to simple, conventional selection of a graphic region representing text using a capture rectangle, the user (or the automated system with the appropriate statement in the database) can, in line with the invention, efficiently select a set of words in the text graphic without being tied to the exact graphical bounds of the word in the graphic, for example, since the selection is made using the word position value for each word. In addition, it becomes possible to recognize words associated with a text section which are not situated within the graphical bounds of a selection region, but part of the flow of the marked text, as part of the selection.

As a result of an attribution region of the text graphic being determined on the basis of the word position value of a word thus recognized as having been selected, it becomes possible to establish for which area-based regions of the text graphic the attribution is performed. This region is ascertained on the basis of the respective word geometry and the word position value and is independent of the region indicated by the selection position value. The attribution region as a whole can be compiled from respective attribution regions of a plurality of words and can in this case be calculated as a rectangle narrowly bounding the respective word, for example. In addition, the height of the individual attribution region may be proportioned on the basis of the word height of that word which produces the greatest height in the chosen font size of the text. Hence, the regions of the text graphic to which the attribution is graphically applied are ascertained.

As a result of the text graphic now being modified in the attribution regions, it becomes possible to apply the attribution to the computer graphic, so that the latter can be presented directly. By way of example, this can be done by applying a graphic filter to the text graphic, such as an alpha filter, or by overlaying the text graphic with a second computer graphic. In the case of “highlight” attribute, this may involve placing uneven or structured yellow or green graphic, for example, opaquely (partially transparently, semi-transparently) over the text graphic. This allows attributions to be performed without this requiring customization of a display unit, or without additional technical complexity arising in the handling, transmission or display of the attributed text graphic.

This allows a number of different attributions to be applied flexibly to words of a text graphic.

Further embodiments of the invention according to claim 1 can be implemented in line with the subclaims which refer back to this claim.

By way of example, the invention may be developed by virtue of the selection position value being determined during a first user session on the basis of a user interaction and being stored in a memory. In this case, a plurality of selection position values can be stored individually for each user, so that the selected text portions can also be processed further at a later time. If, in developments of the invention, the selection position value is retrieved from the memory during a second user session, it is possible to restore the attribution performed in the first session for the user during a later user session on the basis of the stored selection position values.

In developments of the invention, an attribution type is determined which identifies the text attribute to be assigned. This allows the marked text to be processed further in different ways on the basis of the attribution type, for example by virtue of the second computer graphic being selected on the basis of the determined attribution type.

Developments of the invention may be characterized in that the first computer graphic is overlaid with the second computer graphic opaquely. This can be implemented by means of pixel-by-pixel computational image combination operations by retrieving the first and second graphics from the memory, combining them and storing the combination result in the memory. The combination result is the overlaid first graphic.

The invention may be developed in that the attribution region is determined by ascertaining that region of the first computer graphic which is taken up by the graphical word representation.

If the selection position value has a second coordinate tuple related to the first computer graphic, the first and second coordinate tuples can form diagonally opposite points of a rectangular selection region. The corners of the latter provide comparison values which can be used for the comparison operations of the word selection check.

Accordingly, the invention can be developed such that the word position value has a second coordinate tuple related to the first computer graphic and additionally such that the first and second coordinate tuples form diagonally opposite points of a rectangular word region.

As a result, the word selection check with coordinate comparison may be in a form such that the word position value for the word is covered by the selection position value if the word region is at least partially situated in the selection region. So as also to cover words which are not situated in the selection region but are part of the text flow, it is additionally possible for the word selection check to be designed such that the word position value for the word is covered by the selection position value if the word region is at least partially situated between the vertical coordinate of the first coordinate tuple of the selection position value and the vertical coordinate of the second coordinate tuple of the selection position value.

The invention according to claim 14 provides an apparatus for assigning text attributes to a graphical representation of the text which is contained in a computer graphic on the basis of the method proposed in the present case, having a processing unit and a memory,

characterized in that
the memory contains a first computer graphic which has a graphical representation of text;
the processing unit is designed to determine at least one word position value which has a coordinate tuple related to the first computer graphic for a word of the text represented in the first computer graphic;
the processing unit is designed to evaluate at least one selection position value which has a coordinate tuple related to the first computer graphic;
the processing unit is designed to check whether the word position value for the word is covered by the selection position value by comparing the coordinate tuples of the word position value and the selection position value;
the processing unit is designed to determine an attribution region of the first computer graphic on the basis of the word position value covered by the selection position value;
the processing unit is designed to modify the first computer graphic at least in the attribution region.

These devices and forms of the memory and of the processing unit mean that the apparatus is set up to carry out the method according to the invention.

The processing unit can be implemented by program-based setup of multipurpose hardware, such as multipurpose processors, and/or by a combination of programming and application-specific processor components (Application Specific Integrated Circuits, ASICs). In particular, the implementation may involve resorting to functions provided by operating systems or middleware and/or to technologies typical of the Internet, such as PHP (PHP Hypertext Preprocessor) and/or JavaScript.

Embodiments of the invention according to claim 16 can be implemented in accordance with the subclaims which refer back to this claim, and in accordance with the remaining developments and embodiments of all the apparatuses and methods according to the invention.

The invention according to claim 27 provides an arrangement for assigning text attributes to a graphical presentation of text which is contained in a computer graphic, having an inventive or developed apparatus which is in the form of a server and having a client which can be connected to the server via a network, wherein:
the processing unit of the server is designed to transmit a first computer graphic which has a graphical representation of text to the client via the network using a communication interface which is contained in the server;
the client is designed to present the first computer graphic using a user interface which is contained in the client, to accept a user interaction and to transmit the resultant value to the server via the network using a communication interface which is contained in the client,
and the processing unit of the server is designed to evaluate the selection position value on the basis of the transmitted value and to transmit the computer graphic obtained from the modification to the client.

The configuration of the arrangement with client and server makes the arrangement consistent with established architectures for distributed systems, as are in widespread use between service provider computers and service demand computers via the Internet or via mobile radio networks. Hence, the arrangement can be integrated into existing systems without fundamental technical additional complexity.

The invention according to claim 28 provides a computer program product which is stored on a computer-readable storage medium and which contains computer-readable program means for the execution of the steps of the method according to the invention by a computer. The invention according to claim 29 accordingly provides a computer program product which is embodied in a digital carrier wave. By way of example, the digital carrier wave may be provided by a wireless or wired electrical or optical signal or by all forms of the embodiment of the information-carrying bits in a medium. Both computer program products are used for carrying out the method when the program product is executed on a computer.

The computer program product may correspondingly be stored on a magnetic or optical data storage medium, such as a CD-ROM, DVD-ROM, floppy disk or hard disk, or in a semiconductor chip, such as a memory chip or a memory portion of a processor.

### BRIEF DESCRIPTION OF THE DRAWINGS

The invention is explained below by way of example with reference to a plurality of figures, in which:

FIG. 1 shows a schematic overview of an exemplary embodiment of the method,

FIG. 2 shows a schematic overview of an exemplary embodiment of the method in application context,

FIG. 3 shows a schematic overview of an exemplary embodiment of an arrangement for assigning text attributes, having a client and having an apparatus for assignment as a server,

FIG. 4 shows an illustration of a first aspect of the marking process according to the method shown in FIG. 1,

FIG. 5 shows an illustration of a second aspect of the marking process according to the method shown in FIG. 1, and

FIG. 6 shows an illustration of a third aspect of the marking process according to the method shown in FIG. 1.

### DETAILED DESCRIPTION

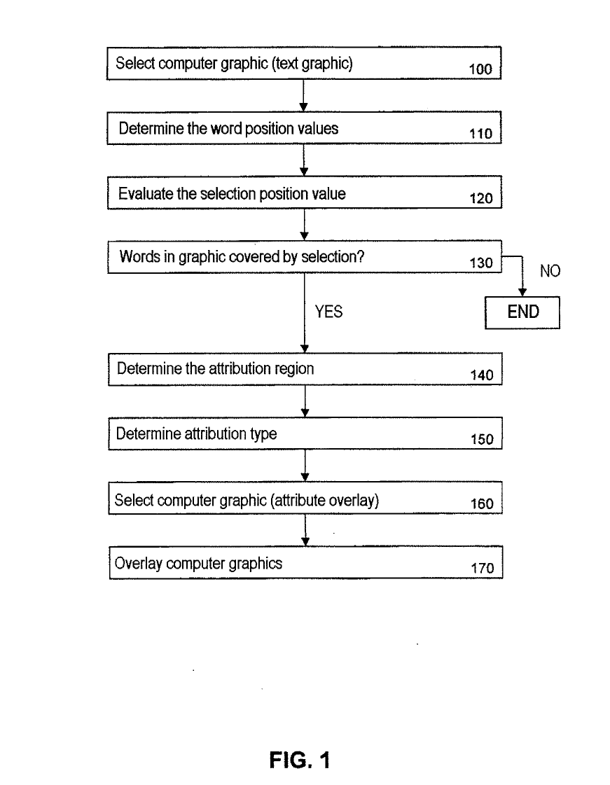

FIG. 1 shows a schematic overview of an exemplary embodiment of the method.

In step 100, the processing apparatus first of all selects a text graphic for further editing in accordance with the process. The text graphic is a computer graphic which has text elements, the text elements not being character-encoded but rather being represented purely graphically in the computer graphic. The computer graphic may be a raster graphic or a vector graphic.

In step 110, the processing apparatus then ascertains the associated word position value, which may contain one or two coordinate tuples, for each word contained in the text graphic. In this case, the coordinate tuple denotes the relative position of the word in the coordinate system of the text graphic. If there are two coordinate tuples, for example, the first may denote the X coordinate and the Y coordinate of the top left-hand corner of the word, and the second coordinate tuple may denote the X coordinate and the Y coordinate of the bottom right-hand corner of the word.

The word position values can be retrieved from a database, for example, which contains the associated word position value for each word of a text graphic, or they can be determined by image processing methods, for example text recognition or optical character recognition (OCR) methods.

In step 120, the processing unit then evaluates one or more selection position values which may come from a user input, for example, or have been retrieved from a database which contains, for each text graphic, selection position values associated therewith.

A selection position value may, like the word position value, be a coordinate tuple or, in a similar manner to the word position value, it may contain two tuples which form the corners of a selection region.

As an alternative to the process described in steps 110 and 120, the selection position value(s) can also be received or retrieved first of all so as then to ascertain only those word position values of the text graphic which could be covered by the selection position value. This preselection, which can be made by evaluating an interval metric around the selection position value, reduces the computation complexity for OCR-based dynamic word position value ascertainment or the access complexity for retrieval from a memory or a database.

In step 130, the processing unit then checks each of the ascertained word position values, i.e. for each word or for each word which is suitable according to the metric, in principle, whether the word represented in the text graphic is covered by the selection position value. In this way, all the words represented in the text graphic are ascertained which need to be selected for the attribution. This can be done by selecting and possibly combining the following four case distinctions, for example, when word position values and selection position values each have two coordinate tuples which are corner points of a region. A word is marked when at least one of the following case distinctions applies:

| 1^{st} case distinction | |
|---|---|
| IF | (BottomRightWord_X >= SelectionStart_X |
| AND | BottomRightWord_Y >= SelectionStart_Y |
| AND | BottomRightWord_Y < SelectionEnd_Y) |
| THEN | MarkWord |
| 2^{nd} case distinction | |
| IF | (TopLeftWord_Y > SelectionStart_Y |
| AND | TopLeftWord_X <= SelectionEnd_X |
| AND | TopLeftWord_Y <= SelectionEnd_Y) |
| THEN | MarkWord |
| 3^{rd} case distinction | |
| IF | (TopLeftWord_Y > SelectionStart_Y |
| AND | BottomRightWord_Y < SelectionEnd_Y) |
| THEN | MarkWord |
| 4^{th} case distinction | |
| IF | (BottomRightWord_X >= SelectionStart_X |
| AND | TopLeftWord_X <= SelectionEnd_X |
| AND | TopLeftWord_Y <= SelectionStart_Y |
| AND | TopLeftWord_Y <= SelectionEnd_Y |
| AND | BottomRightWord_Y >= SelectionStart_Y |
| AND | BottomRightWord_Y >= SelectionEnd_Y) |
| THEN | MarkWord |

In all case distinctions, “TopLeft” is the first word position coordinate tuple and “BottomRight” is the second word position coordinate tuple and “Start” is the first selection position coordinate tuple and “End” is the second selection position coordinate tuple. A person skilled in the art will see from this that with appropriate adaptation of the case distinction conditions it is also possible to use a “TopRight” and a “BottomLeft” as the first and second word position coordinate tuples. “X” and “Y” are the X and Y coordinates of the coordinate tuple. In the exemplary coordinate system, the coordinate statements for a raster computer graphic run from the origin in the top left-hand corner to the right in the X direction and downward in the Y direction.

The first case distinction checks whether the bottom right-hand point of the word is situated identically or further right to/than the starting point of the marker, and at the same time the bottom right-hand point of the word is situated at the same height or lower as/than the starting point of the marker, and also at the same time the bottom right-hand point of the word is situated higher than the end point of the marker.

The second case distinction checks whether the top left-hand point of the word is situated lower than the starting point of the marker and at the same time the top left-hand point of the word is situated identically or indeed further left to/than the end point of the marker, and also at the same time the top left-hand point is situated at the same height or indeed higher as/than the end point of the marker.

The third case distinction checks a situation which is related to the first case distinction but converse in respect of the selection position values. In this case, the processing unit checks whether the top left-hand point of the word is situated lower than the starting point of the marker and the bottom right-hand point of the word is situated higher than the end point of the marker.

Finally, the fourth case distinction checks whether the bottom right-hand point of the word is situated identically or indeed further right to/than the starting point of the marker, at the same time the top left-hand point is situated identically or indeed further left to/than the end point of the marker, at the same time the top left-hand point is situated at the same height or indeed higher as/than the starting point of the marker, again at the same time the top left-hand point is situated at the same height or indeed higher as/than the end point of the marker, in addition the bottom right-hand point of the word is situated at the same height or indeed lower as/than the starting point of the marker, and finally the bottom right-hand point is situated at the same height or indeed lower as/than the end point of the marker.

The case distinctions can possibly be implemented in logically equivalent different case distinction constructs by means of programming or circuitry.

The selection scenarios are clearly covered by the four case distinctions cited above as in the table below. The rows denote the position of the starting point relative to the position of the word in the coordinate system, and the columns denote the position of the end point relative to the position of the word in the coordinate system. The statement in the table cell denotes the respective instance of the four case distinctions described above.

| | | | below | | below |
|---|---|---|---|---|---|
| | inside | right | left | below | right |
| above | 2^{nd} | 2^{nd} | 1^{st} | 1^{st} | 1^{st} |
| left | | | | | |
| above | 2^{nd} | 2^{nd} | 1^{st} | 1^{st} | 1^{st} |
| above | 2^{nd} | 2^{nd} | 3^{rd} | 2^{nd} | 2^{nd} |
| right | | | | | |
| left | 4^{th} | 4^{th} | 1^{st} | 1^{st} | 1^{st} |
| inside | 4^{th} | 4^{th} | 1^{st} | 1^{st} | 1^{st} |

As a result of the case distinction in step 130, the processing unit therefore ascertains the quantity of the words which are covered by the selection position value or the underlying selection operation by a user. This may be a quantity or a vector of word position values. If no word is affected by the selection, the method can be terminated at this juncture.

For each of the word position values ascertained in step 130 and affected by the selection position value or the selection position values, the processing unit then calculates in step 140 a region which surrounds the respective word in the text graphic representation. The attribution region is different from the word position value. In practical implementations, the attribution region is a region of the text graphic which narrowly bounds the word in horizontal extent and, in the vertical extent, is as high as the word at maximum height in the same font and font size of the word which is to be attributed. This ensures graphically even-height attribution in continuous text arranged in lines, regardless of the actual word height of individual words which are to be attributed. In addition, the processing unit determines the overall attribution region for the overall text graphic by summing the individual regions in step 140.

On the basis of the attribution to be performed, which can be selected by user interaction and then determined as appropriate in step 150, for example, the processing unit then selects in step 160 a computer graphic which, in combination with the text graphic, produces a visual effect which corresponds to the attribution. Alternative embodiments may provide for a graphic filter to be selected, instead of or in addition to a second computer graphic and the overlay, on the basis of the attribution to be applied, for example an alpha filter, or the like, which is applied to the text graphic. For highlighting in the manner of a highlighter pen, it is possible to select a smooth or felt-tip textured, two-dimensional yellow or green computer graphic as an overlay graphic which may be semitransparent or opaque and which is then arithmetically combined with the text graphic by the processing unit in step 170 to form a result graphic by overlaying the text graphic with the overlay graphic. In this case, in contrast to conventional highlighting effects, not only is the background color altered but also, at the same time, the font color is gradually colored, which also improves the visual effect of the highlighting.

Alternatively, the overlay computer graphic may also be in the form of a nontransparent graphic, with the semitransparent or opaque effect being produced dynamically during the arithmetic combination.

In this case, the overlay takes place only in those regions of the text graphic which are attribution regions, while the remaining regions remain unchanged.

As an alternative to the highlighting, frames are also possible by virtue of a transparent overlay graphic being produced dynamically with a solid frame representation in the size of the attribution region.

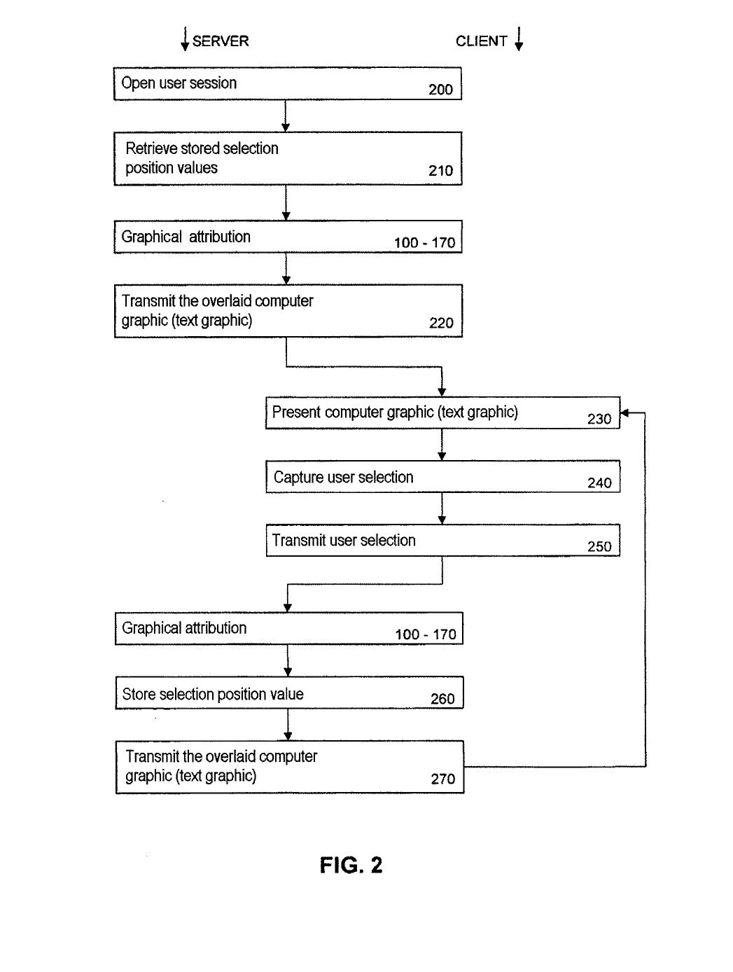

FIG. 2 shows a schematic overview of an exemplary embodiment of the method in an application context.

In step 200, a user session is opened on the apparatus for assigning text attributes, which in the present case is implemented as a server. For this purpose, said server may have received a suitable request from a user on a computer, which in the present case is implemented as a client, for example in the course of logging in. Said client may in this case contain a web client, and the server may contain a web server, the web client and the web server being set up as appropriate to carry out the method.

In step 210, the processing unit of the server then retrieves specifically stored selection position values for the registered user from a database which the user has created in a previous user session. The processing unit of the server then performs the attribution method, as has been shown with reference to FIG. 1 in steps 100-170. The resultant overlaid computer graphic with the attributed text elements is then transmitted via the Internet to the web client, which presents the attributed text graphic in step 230. By indicating a starting point and an end point, the user selects a selection region and also selects an attribution type which is presented to the user via a user interface by the client and captured in step 240. The client then transmits these values for the user selection in step 250 to the server, which accordingly adopts these values as a selection position value or derives the selection position value arithmetically therefrom, and again performs the attribution method in steps 100 to 170.

In this case, the processing unit of the server adds the selection position value to the one already stored on a user-specific basis in the database by storing the selection position value in step 260. In step 270, the server transmits the recently attributed, overall text graphic to the client for presentation.

In an alternative embodiment, the storage of the selection position values in step 260 can take place directly after the transmission of the user selection in step 250 and acceptance or calculation of the selection position value therefrom, and accordingly the attribution method in steps 100 to 170 can be performed after the storage in step 260.

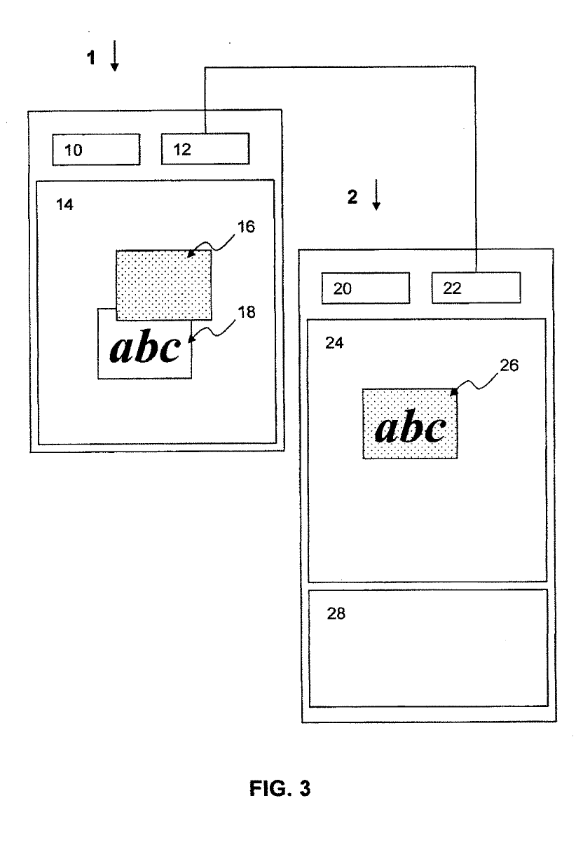

FIG. 3 shows a schematic overview of an exemplary embodiment of an arrangement for assigning text attributes, having a computer, which is in the present case in the form a client, and having an apparatus for assigning text attributes as a server.

The apparatus for assigning text attributes, which is in the form of a server 1, has a processing unit 10, a communication interface 12 and a memory 14 which are all communicatively coupled to one another, for example by a computer-internal bus system. If the tasks are distributed between individual computers, the connection between a processing computer, a communication gateway and a database server via a local area network can be made in an equivalent manner.

In particular, the processing unit 10 is set up to perform steps 100 to 170 of the method and, in a present client/server configuration, also steps 200-220 and 260 and 270. For this, the processing unit can also implement functions of an operating system and a web server. For the purpose of communication via a network, the processing unit 10 uses the communication interface 12, which is set up for communication over the Internet via TCP/IP, or over cellular mobile radio networks, for example.

The memory 14 contains or references a first computer graphic 18 which graphically represents text components. In this case, the computer graphic 18 is a raster or vector graphic which represents the characters in the text by means of pixels or vectors without containing the text in character-encoded form, for example in an ASCII, ISO 8859-1 or Unicode format, and is usually referred to as a text graphic.

For example, a quantity of text arranged in lines may thus be presented in the text graphic which represents the flow of text on a book page.

In addition, the memory 14 contains or references a second computer graphic 16 (overlay graphic) which has a colored area or texture or another graphical form which corresponds to an attribution which needs to be assigned to the text graphic or portions thereof, i.e. words therein. Thus, for attribute assignment of this “highlighted” attribute, it is possible to select a colored, for example yellow or green, two-dimensional texture. In this case, the second computer graphic 16 may be opaque, i.e. may have a particular degree of transparency which can be determined by an alpha channel of the graphic 16. The alpha channel for the graphic may be present internally or in an external data management system. Alternatively, it is also possible to use a nontransparent graphic as second computer graphic 16 if the processing unit 10 is designed to perform step 170 of the overlaying of the graphics such that the result is that the second graphic appears in a form opaquely overlaid over the first.

The client 2 is a computer which a user uses for interaction and which communicates with the server 1 via a web client or a display program for electronic documents, for example, in order to retrieve text graphics and program or HTML code for the user interface which is to be presented on the client from the server and to present and/or execute same.

In this case, client 2 comprises a processing unit 20, which can be implemented with a programmed general purpose processor, for example, and a communication interface 22 (network stack) connected to said processing unit and a memory 24, which in turn has a text graphic 26.

In addition, a user interface, for example a graphical user interface (GUI), which is controlled by a pointer or a touch screen, is contained in the client 2 or connected thereto. The text graphic 26 is presented to the user via the user interface 28 together with appropriate selection and menu options, and the user interface receives commands from the user by obtaining appropriate command values from the user actions.

In particular, the processing unit 20 is set up to interact with the server and to perform steps 230 to 250 of the method. Furthermore, the processing unit is designed to capture a user identification and to transmit it to the server 1, which then opens a user session and retrieves values stored on a user-specific basis.

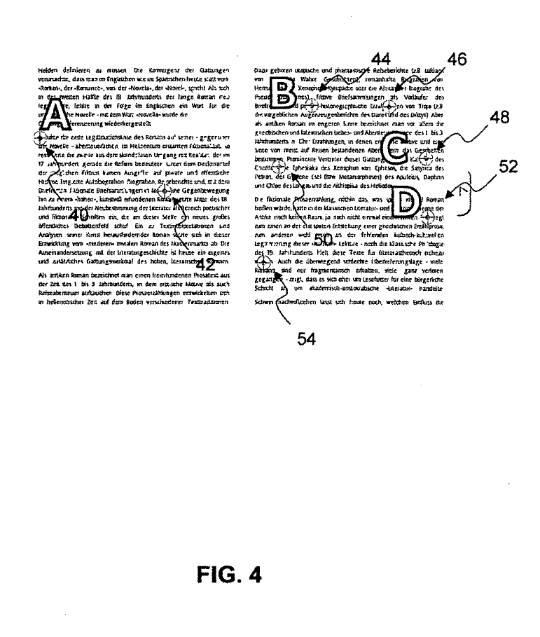

FIG. 4 shows an illustration of a first aspect of the marking process according to the method shown in FIG. 1.

The figure shows four regions A, B, C, D of a text graphic which shows a double page of an open book with text flowing in lines. The four regions A, B, C and D are each regions in which the attribute “highlighting” has been assigned to the text presented therein in accordance with the method. As the figure shows, a graphical identifier—presented in gray—has been added to the attributed text portion of the graphic, with the portions shown in gray simultaneously denoting the attribution region—determined in accordance with the method—of the text graphic. For the purpose of clarification, each of the regions also has the associated selection position value clarified, which in the present case comprises two respective coordinate tuples. This is point 40 as start coordinate tuple of the marker and point 42 as end coordinate tuple for the region A, the point 44 as start coordinate tuple of the marker and point 46 as end coordinate tuple for the region B, the point 48 as start coordinate tuple of the marker and the point 50 as end coordinate tuple for the region C, and finally the point 52 as start coordinate tuple of the marker and point 54 as end coordinate tuple for the region D.

From region C, in particular, it becomes clear that words and regions of the text graphic have also been attributed which are not at least partially contained in a capture rectangle defined by the start and end coordinate tuples but rather are situated completely outside. In addition, it can be seen here that the attributed graphic regions are all the same height and do not vary with the actual word height. This is ensured by virtue of the attribution region being calculated independently of the actual word height, in principle.

In variants of the method, the calculation of the text graphic region to be attributed for each individual word can actually be brought forward to the determination of the word position value of the respective word, for example by virtue of each individual word having a boundary, as a word position value, determined for it which matches the attribution region of the respective word as defined further above. In this case, the word position value can be adopted directly as an attribution region for the respective word, and then only the overall attribution region for the overall text graphic is determined in step 140.

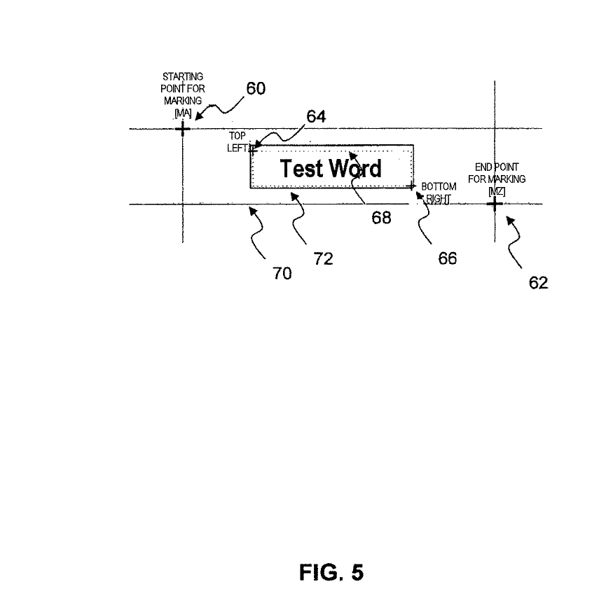

FIG. 5 shows an illustration of a second aspect of the marking process according to the method shown in FIG. 1, particularly for the individual regions, position values and coordinate tuples relative to one another.

In a text graphic with a plurality of words, a first coordinate tuple for a selection position value provides a starting point 60 for a selection by a user, and a second coordinate tuple for the same selection position value provides an end point 62 for the selection. The selection region can therefore be regarded as a rectangular selection region 70. In contrast to the conventional capture rectangle, however, the special case distinctions in step 130 do not merely involve words which at least partially fall within the rectangle, as also illustrated in FIG. 4 for region C. In this respect, FIG. 5 shows a special case in which the “test word” falls exactly in the selection region 70.

Accordingly, in the present case, a first coordinate tuple of a word position value provides a top left-hand corner 64 of a word, and a second coordinate tuple for the same word position value provides a bottom left-hand corner 66 of the word, which defines a rectangular word region 68 (shown with a dotted outline).

This accordingly involves calculation of an attribution region 72 (in this case shown as a box) surrounding the word region 68 by means of an interval region. By way of example, the interval region is proportioned such that it is as high as the word of maximum height in the same font and font size of the word which is to be attributed. In this case, the width adopted can be the width of the word region, or a horizontal interval region oriented to the word interval can be added on between the word region and the edge of the attribution region.

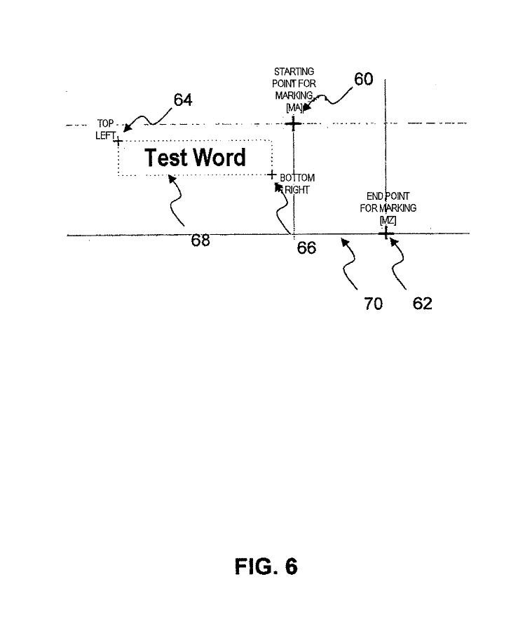

FIG. 6 shows an illustration of a third aspect of the marking process according to the method shown in FIG. 1.

The elements referenced by the reference symbols correspond to those in FIG. 5, where the present figure once again gives a detailed presentation of the case in which a word has its word region situated entirely outside the rectangle formed by the selection position value.

An appropriate entry for storing the selections and/or attributions can be made in a user or user session database, for example using fields respectively for a document identifier for identifying the document which is presented by the text graphic, a page identifier for identifying the document page, a start coordinate tuple for the selection position value, an end coordinate tuple for the selection position value, a coordinate tuple for a top left-hand corner of the word position value, a coordinate tuple for a bottom right-hand corner of the word position value, and a time stamp.

The present system therefore provides the option of providing text in text graphics, which is not in character-encoded form but rather is represented purely graphically in the text graphic, with attributes such as highlighting or framing without this requiring parallel provision of the text in character-encoded form, and without the need to select that text of the text graphic which is to be subjected to attribution using the conventional marking methods for computer graphics.

This allows the section of the text which is to be attributed to be defined by a starting point and an end point for a marker, for example, and the exact positioning of a capture rectangle around each of the text portions to be marked is unnecessary. A user can therefore provide a marker by means of just two mouse clicks, for example, and, when a book page is being shown, for example, obtains a marker for all the words in the text flow which are between the two points. A user can also use the present system to store all the attributions during a user session and have them restored in a later user session. For use by a plurality of users, the present system merely stores the selection and attribution information, so that the attribution can firstly be restored individually and differently for each user but secondly avoids multiple storage of the attributed text graphics, since in each case the attribution is restored on the basis of the original text graphic, and therefore becomes substantially resource-saving when there are a large number of users. Overlaying the text graphic with the opaque graphical representation of the text attribute can also improve the visual impression. In this case, the system can easily be developed such that a marker extends over a plurality of presented pages of the text graphic by virtue of the marker being shown on a first page up to the last word in the last line, by virtue of an end point being inserted at that point, and starting again on the next page at the first word in the first line, by virtue of a starting point being inserted at that point.

As a person skilled in the art will recognize from the preceding illustrations and explanations, the text attributed in such a manner may be in the presentation context of an open book page with textural and other contents. By way of example, the user interface 28 shown in FIG. 3, which may be in the form of a GUI, may thus display a book text as shown in FIG. 4.

The steps (cf. FIG. 2 and the description relating thereto) to be performed in the apparatus 1, which may be in the form of a server or in the form of a web server, may be implemented by a piece of software which contains instructions to perform the respective steps and which is contained in the memory 14. Accordingly, the steps (cf. likewise FIG. 2 and the description relating thereto) to be performed in the computer 2, which may be in the form of a client or in the form of a web client, may be implemented by a piece of software which contains instructions to perform the respective steps and which is contained in the memory 24. In this case, the software can be executed by a general purpose processor, or additionally by resorting to specific functionalities provided by supplementary software. Thus, the computer is able to provide the presentation in functional conjunction with a web browser installed on the computer, or with other, proprietary display programs, for example when the computer is implemented by a mobile terminal, such as a mobile telephone.

The software to be executed on the computer 2 can be preinstalled, for example as a plug-in module for display software or as a browser plug-in, or, in the case of a web browser, it can also be put onto the computer or integrated into programs contained therein by transmitting program instructions embedded in a WWW page. In the latter case, the program instructions embedded with the WWW page call functions contained in the browser, such as JavaScript functions. As a person skilled in the art will readily recognize, the invention is therefore not limited to the use of plug-ins.

### LIST OF REFERENCE SYMBOLS

1 Apparatus for assigning text attributes (server)
2 User computer (client)
10 Processing unit
12 Communication interface
14 Memory
16 Second computer graphic (text attribute overlay)
18 First computer graphic with text graphic
20 Processing unit
22 Communication interface
24 Memory
26 Overlaid computer graphic
28 User interface
40 Starting point for selection region A
42 End point for selection region A
44 Starting point for selection region B
46 End point for selection region B
48 Starting point for selection region C
50 End point for selection region C
52 Starting point for selection region D
54 End point for selection region D
60 Starting point for selection region
62 End point for selection region
64 First corner point for word region
66 Second corner point for word region
68 Word region
70 Selection region
72 Attribution region for a word
100 Select the first computer graphic (text graphic)
110 Determine the word position values
120 Evaluate the selection position value
130 Check whether words in graphic covered by selection
140 Determine the attribution region
150 Determine the attribution type
160 Select the second computer graphic (attribute overlay)
170 Overlay the computer graphics
200 Open a user session
210 Retrieve stored selection position values
220 Transmit the overlaid computer graphic
230 Present the computer graphic
240 Capture the user selection
250 Transmit the user selection
260 Store the selection position value
270 Transmit the overlaid computer graphic

1. A method for assigning text attributes to a graphical representation of text which is contained in a computer graphic, having the following steps:
a first computer graphic which has a graphical representation of text is selected;
at least one word position value which has a coordinate tuple related to the first computer graphic is determined for a word of the text represented in the first computer graphic;
at least one selection position value which has a coordinate tuple related to the first computer graphic is evaluated;
a check is performed to determine whether the word position value for the word is covered by the selection position value by comparing the coordinate tuples of the word position value and the selection position value;
an attribution region for the first computer graphic is determined on the basis of the word position value covered by the selection position value;
the first computer graphic is modified at least in the attribution region.

2. The method as claimed in claim 1, characterized in that the selection position value is determined during a first user session on the basis of a user interaction and is stored in a memory.

3. The method as claimed in claim 2, characterized in that the selection position value is retrieved from the memory during a second user session.

4. The method as claimed in one of claims 1 to 3, characterized in that an attribution type is determined which identifies the text attribute to be assigned.

5. The method as claimed in one of claims 1 to 4, characterized in that a second computer graphic is selected and the first computer graphic is overlaid with the second computer graphic.

6. The method as claimed in claim 5, characterized in that the first computer graphic is overlaid with the second computer graphic opaquely.

7. The method as claimed in one of claims 1 to 6, characterized in that the attribution region is determined by ascertaining that region of the first computer graphic which is taken up by the graphical word representation.

8. The method as claimed in one of claims 1 to 7, characterized in that the selection position value has a second coordinate tuple related to the first computer graphic.

9. The method as claimed in claim 8, characterized in that the first and second coordinate tuples form diagonally opposite points of a rectangular selection region.

10. The method as claimed in one of claims 1 to 9, characterized in that the word position value has a second coordinate tuple related to the first computer graphic.

11. The method as claimed in claim 10, characterized in that the first and second coordinate tuples form diagonally opposite points of a rectangular word region.

12. The method as claimed in claims 9 and 11, characterized in that the word position value for the word is covered by the selection position value if the word region is at least partially situated in the selection region.

13. The method as claimed in claims 9 and 11 or as claimed in claim 12, characterized in that the word position value for the word is covered by the selection position value if the word region is at least partially situated between the vertical coordinate of the first coordinate tuple of the selection position value and the vertical coordinate of the second coordinate tuple of the selection position value.

14. An apparatus for assigning text attributes to a graphical representation of text which is contained in a computer graphic according to the method as claimed in one of claims 1 to 13, having a processing unit and a memory,
characterized in that
the memory contains a first computer graphic which has a graphical representation of text;
the processing unit is designed to determine at least one word position value which has a coordinate tuple related to the first computer graphic for a word of the text represented in the first computer graphic;
the processing unit is designed to evaluate at least one selection position value which has a coordinate tuple related to the first computer graphic;
the processing unit is designed to check whether the word position value for the word is covered by the selection position value by comparing the coordinate tuples of the word position value and the selection position value;
the processing unit is designed to determine an attribution region of the first computer graphic on the basis of the word position value covered by the selection position value;
the processing unit is designed to modify the first computer graphic at least in the attribution region.

15. The apparatus as claimed in claim 14, characterized in that a communication interface is also included which is designed to receive a value resulting from a user interaction, and the processing unit is designed to determine the selection position value during a first user session on the basis of the value and to store it in the memory.

16. The apparatus as claimed in claim 15, characterized in that the processing unit is designed to retrieve the selection position value from the memory during a second user session.

17. The apparatus as claimed in one of claims 14 to 16, characterized in that the processing unit is designed to determine an attribution type which identifies the text attribute to be assigned.

18. The apparatus as claimed in claim 17, characterized in that the processing unit is designed to select a second computer graphic.

19. The apparatus as claimed in claim 18, characterized in that the processing unit is designed to overlay the first computer graphic with the second computer graphic opaquely.

20. The apparatus as claimed in one of claims 14 to 19, characterized in that the processing unit is designed to determine the attribution region by ascertaining that region of the first computer graphic which is taken up by the graphical word representation.

21. The apparatus as claimed in one of claims 14 to 20, characterized in that the selection position value has a second coordinate tuple related to the first computer graphic.

22. The apparatus as claimed in claim 21, characterized in that the first and second coordinate tuples form diagonally opposite points of a rectangular selection region.

23. The apparatus as claimed in one of claims 14 to 22, characterized in that the word position value has a second coordinate tuple related to the first computer graphic.

24. The apparatus as claimed in claim 23, characterized in that the first and second coordinate tuples form diagonally opposite points of a rectangular word region.

25. The apparatus as claimed in claims 22 and 24, characterized in that the word position value for the word is covered by the selection position value if the word region is at least partially situated in the selection region.

26. The apparatus as claimed in claims 22 and 24 or as claimed in claim 25, characterized in that the word position value for the word is covered by the selection position value if the word region is situated between the vertical coordinate of the first coordinate tuple of the selection position value and the vertical coordinate of the second coordinate tuple of the selection position value.

27. An arrangement for assigning text attributes to a graphical representation of text which is contained in a computer graphic, having an apparatus in the form of a server as claimed in one of claims 14 to 26 and having a client which can be connected to the server via a network, wherein:
the processing unit of the server is designed to transmit a first computer graphic which has a graphical representation of text to the client via the network using a communication interface which is contained in the server;
the client is designed to present the first computer graphic using a user interface which is contained in the client, to accept a user interaction and to transmit the resultant value to the server via the network using a communication interface which is contained in the client,
and the processing unit of the server is designed to evaluate the selection position value on the basis of the transmitted value and to transmit the computer graphic obtained from the modification to the client.

28. A computer program product, stored on a computer-readable storage medium, having computer-readable program means for the performance of the method as claimed in one of claims 1 to 13 by a computer.

29. A computer program product, embodied in a digital carrier wave, having computer-readable program means for the performance of the method as claimed in one of claims 1 to 13 by a computer.
